(19) United States
(12) Patent Application Publication
(10) Pub. No.: US 2012/0132147 A1
(43) Pub. Date: May 31, 2012

(54) PUPPY TRAINING PAD

(76) Inventor: Gang Cheng, Jiujiang District Wuhu City (CN)

(21) Appl. No.: 13/296,574

(22) Filed: Nov. 15, 2011

(30) Foreign Application Priority Data
Nov. 25, 2010 (CN) 201020625495.4

(51) Int. Cl. A01K 1/01; A01K 29/00

(52) U.S. Cl. 119/161

(57) ABSTRACT

An ultra thin disposable pet pad may have a high pressure polyethylene cast film as a bottom layer, a non woven fabric as a top layer and a liquid absorbing material as a middle layer. The absorbent material may be a super absorbent polymer disposed between the top and bottom layers. The pet pad may be rolled for convenient storage and transportation. The absorbent material may extend to the edges of the top and bottom layers. The pet pad may be cut to size and re rolled for convenient carry.

### CROSS-REFERENCE TO RELATED APPLICATIONS

This application claims priority to patent application serial number 201020625495.4, filed with the State Intellectual Property Office of the People's Republic of China on Nov. 25, 2010, the entire contents of which is expressly incorporated herein by reference.

### STATEMENT RE: FEDERALLY SPONSORED RESEARCH/DEVELOPMENT

Not Applicable

### BACKGROUND

The present invention relates generally to an ultra-thin absorbent pad for use by pet owners for the collection of pet waste products.

Pets have become important “members” of many families. While pet owners enjoy the companionship provided by their pets, pet sanitation is a less glamorous yet necessary challenge of pet ownership. The disposal of pet waste products is an especially important consideration when the pets are young and untrained.

There are various prior art pet sanitary products, such as pet training pads, bird cage mats, and disposal bags that have been previously used to collect waste products. These prior art pet sanitary products absorb pet urine with a wood pulp medium. Unfortunately, the wood pulp must remain generally flat. Accordingly, transporting and carrying the prior art pet sanitary product is bulky and cumbersome.

Accordingly, there is a need in the art for an improved pet sanitary product for use in the collection of pet waste.

### BRIEF SUMMARY

The pad disclosed herein addresses the needs discussed above, discussed below and those that are known in the art.

An absorbent pad for use by pet owners for the collection of pet waste products is disclosed herein. The pad includes first, second, third, fourth and fifth layers. Although five layers are disclosed, it is contemplated that the pad may comprise three or more layers. The first layer may be a high pressure polyethylene cast layer. Preferably, the first layer is impermeable to liquid. The first layer contacts the ground when the pad is in use. The first layer prevents the pet urine from seeping through pad and contaminating the ground or floor. The second layer may be tissue paper and disposed on the first layer. The third layer may be a super absorbent polymer and disposed on the second layer. The fourth layer may also be tissue paper and disposed on the third layer so that the second and fourth layers sandwiches the third layer or the super absorbent polymer. The fifth layer may be a non woven fabric and readily allows liquid (e.g., pet urine) to flow therethrough and be absorbed by the third layer or the super absorbent polymer.

The first, second, third, fourth and fifth layers may all be thin and preferably collectively be no more than about 0.25 mm thick. Moreover, the first through fifth layers may be stacked upon each other. Although not by way of limitation, the stack of layers (i.e., pad) may be rolled up for compact and convenient transport. To use the pad, the user may unroll the pad and lay the pad on the ground. The first through fifth layers may also be coextensive with each other so that the entire footprint of the pad may be utilized to capture and retain liquid. The third layer which is fabricated from the super absorbent polymer may extend out to the edges of the first, second, fourth and fifth layers. The pad can also be cut to size as desired then rolled up for subsequent use.

More particularly, an ultra-thin absorbent pad for use by pet owners for the collection of pet waste products is disclosed. The pad may comprise a first layer fabricated from a thin liquid impermeable layer; a fifth layer fabricated from a thin liquid permeable layer; and a third layer fabricated from a super absorbent polymer disposed between the thin liquid impermeable layer and the thin liquid permeable layer. The thin liquid impermeable layer, thin liquid permeable layer and the super absorbent polymer when stacked upon and attached to each other may remain flexible so that the pad is capable of being rolled for convenient storage and transportation.

The first layer may be a high-pressure cast polyethylene plastic film.

A second layer may be disposed between the first and third layers. The second layer may be constructed from a paper material. The second layer may be tissue paper.

The third layer may be a super absorbent polymer spread between the first and fifth layers.

A fourth layer may be disposed between the third and fifth layers. The fourth layer may be constructed from a paper material. The fourth layer may be tissue paper.

The fifth layer may be a non-woven fabric.

The pad may have a rectangular configuration when unfolded.

An adhesive may be disposed between one or more of the first layer, the second layer, the third layer, the fourth layer, and the fifth layer for attaching the layers to each other.

The thickness of the pad may be about or less than 0.25 mm.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of the pad in an open flat position on the ground with a pet sitting thereon;

FIG. 2 is a cross sectional view of the pad illustrating stacked first, second, third, fourth and fifth layers; and

FIG. 3 is a perspective view of the pad in a “rolled up” position.

### DETAILED DESCRIPTION

Referring now to the drawings, a multi layered absorbent pad 10 for absorbing liquid (e.g., pet urine) is disclosed. The pad 10 may be ultra thin and have a thickness 12 of about 0.25 mm or less. The pad 10 is capable of being cut to size. The pad 10 may be rolled, sold and transported in a rolled form. The multi layered absorbent pad 10 has a liquid impermeable layer (i.e., first layer) 14 and a non woven fabric layer (i.e., fifth layer) 16 with a super absorbent polymer 18 sandwiched between the liquid impermeable layer 14 and the non woven fabric layer 16. The pad 10 may be sold in the rolled form. Since the super absorbent polymer 18 can extend to the edges of the pad 10, the user may unroll the pad 10 and cut the pad 10 to size as desired or needed. The user may then re-roll the pad 10 for subsequent use.

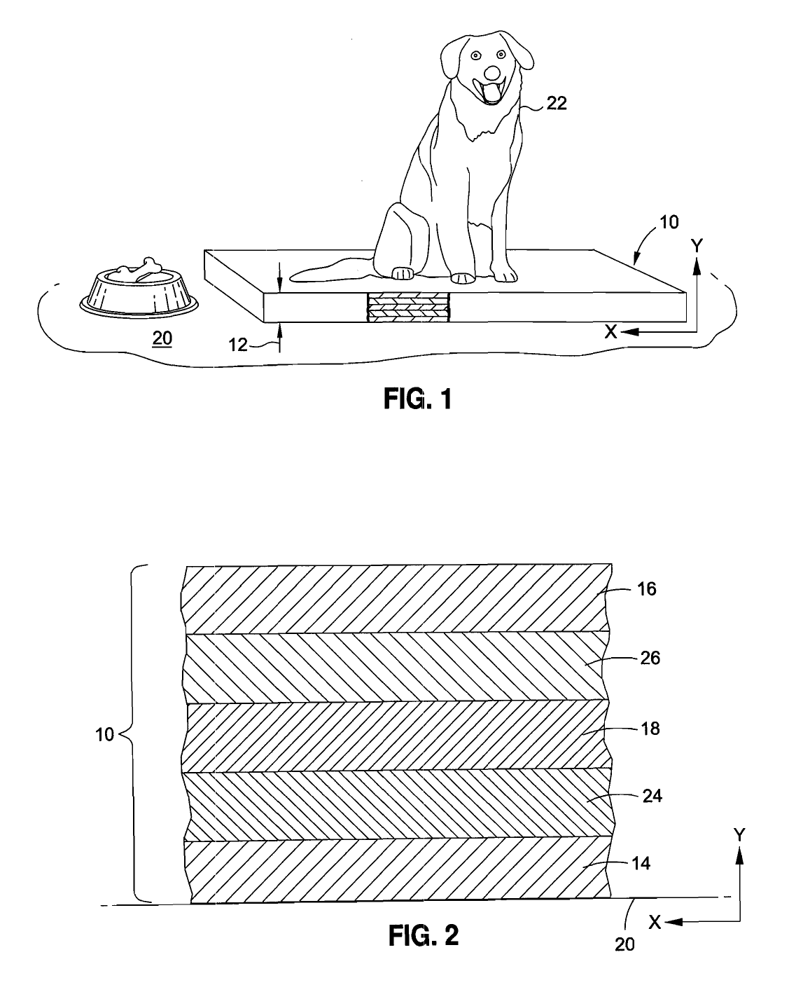

Referring now to FIG. 1, the absorbent pad 10 may be used by pet owners for the collection of pet waste products such as urine and feces. The absorbent pad 10 may be ultra thin and may have a thickness 12 of about 0.25 mm. During use, the pad 10 may be unrolled and laid down on the ground 20 so that the pet 22 may urinate or poop on the absorbent pad 10. The user may then collect the urine or poop. If the pad 10 is too large for the area in which it is being used, the pad 10 may be cut down to size. The super absorbent polymer 18 may extend to the edges of the pad 10 and do not require a barrier to be contained with the stack of layers 14,16, 18.

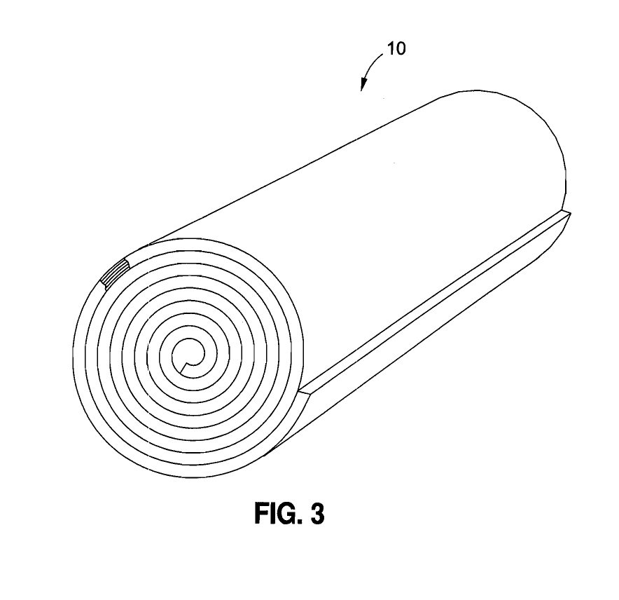

Referring now to FIG. 2, the first layer 14 may be a sheet of a high-pressure cast polyethylene plastic film. This first layer 14 is generally water impermeable and contacts the ground or floor 20 during use of the pad 10. As such, when the pet 22 urinates on the pad 10, the urine does not contaminate the ground or floor 20. The user may fold up the pad 10 and discard the pet waste and the pad 10 simultaneously. Materials other than polyethylene are contemplated so long as the material is thin, rollable, and liquid impermeable.

A second layer 24 may be disposed on the first layer 14. This second layer 24 is also ultra thin. By way of example and not limitation, this second layer 24 may be fabricated from a paper product such as tissue paper. Other materials are also contemplated.

The third layer 18 may be disposed on the second layer 24. The third layer 18 may be made of a highly absorbent and flexible polymer. The third layer may be a super absorbent polymer such as AQUA KEEP manufactured by Sumitomo Seika. The super absorbent layer may be spread over the second layer and disposed under a fourth layer 26 discussed herein. The third layer 18 may also be ultra thin.

The fourth layer 26 may be disposed on the third layer 18. The fourth layer 18 is also ultra thin. By way of example and not limitation, the fourth layer 18 may be fabricated from a paper product such as tissue paper. Other materials are also contemplated.

The fifth layer 16 may be disposed on the fourth layer 26 and may also interface with the pet 22. The fifth layer 16 may be a non-woven fabric. By way of example and not limitation, the fifth layer 16 may be a cotton fiber or other similar material.

The pad 10 may be a single use disposable product after having captured pet waste products. The pad 10 is therefore unique in having a reduced thickness while continuing to have highly absorptive properties. These characteristics also enable the pad 10 to be “roll packaged”. Accordingly, the pad 10 may be especially well suited for storage in tight quarters and may be quickly and efficiently installed by “unrolling” the pad 10 from a rolled position to a flat open position on the ground or floor. These characteristics may also enable the pad 10 to be readily transported before use or disposed of after capturing pet waste products.

As shown in FIG. 3, the pad 10 may be “rolled up” in a rolled position for packaging or for storage. In FIG. 1, the pad 10 is shown “unrolled” in the open position with a pet 22 shown standing thereon. Once the pad 10 has captured pet waste products, the pad 10 may once again be “rolled up” or folded for disposal.

The pad 10 may be substantially rectangular. However, it is contemplated that the pad 10 may assume any shape that is conducive to capturing pet's waste products when laid flat on the ground in an open position and that can be “rolled up” when stored or disposed of. For example, the pad 10 may be substantially circular or oval.

The pad 10 disclosed herein is ultra thin. However, a thicker embodiment is also contemplated. By way of example and not limitation, the first, second, fourth and fifth layers 14, 16, 18 may be sufficiently thick so that the pad cannot be rolled. By way of example and not limitation, the second and fourth layers 24, 26 may be fabricated from card stock instead of tissue paper. Further, it is contemplated that the pad 10 can be fabricated and cut to a desired size and stacked for storage and shipping in addition to being rolled.

The above description is given by way of example, and not limitation. Given the above disclosure, one skilled in the art could devise variations that are within the scope and spirit of the invention disclosed herein. Further, the various features of the embodiment disclosed herein can be used alone, or in varying combinations with each other and are not intended to be limited to the specific combination described herein. Thus, the scope of the claims is not to be limited by the illustrated embodiments.

What is claimed is:

1. An ultra-thin absorbent pad for use by pet owners for the collection of pet waste products, the pad comprising:
a first layer fabricated from a thin liquid impermeable layer;
a fifth layer fabricated from a thin liquid permeable layer;
a third layer fabricated from a super absorbent polymer disposed between the thin liquid impermeable layer and the thin liquid permeable layer;
wherein the thin liquid impermeable layer, thin liquid permeable layer and the super absorbent polymer when stacked upon and attached to each other remain flexible so that the pad is capable of being rolled for convenient storage and transportation.

2. The pad of claim 1 wherein the first layer is a high-pressure cast polyethylene plastic film.

3. The pad of claim 1 further comprising a second layer disposed between the first and third layers, the second layer constructed from a paper material.

4. The pad of claim 3, wherein the second layer is tissue paper.

5. The pad of claim 1, wherein the third layer is a super absorbent polymer spread between the first and fifth layers.

6. The pad of claim 1 further comprising a fourth layer disposed between the third and fifth layers, and the fourth layer is constructed from a paper material.

7. The pad of claim 6, wherein the fourth layer is tissue paper.

8. The pad of claim 1, wherein the fifth layer is a non-woven fabric.

9. The pad of claim 1 wherein the pad is rectangular when unfolded.

10. The pad of claim 1, wherein an adhesive is disposed between one or more of the first layer, the second layer, the third layer, the fourth layer, and the fifth layer for attaching the layers to each other.

11. The pad of claim 1 wherein a thickness of the pad is about or less than 0.25 mm.
